(19) United States
(12) Patent Application Publication
(10) Pub. No.: US 2017/0320728 A1
(43) Pub. Date: Nov. 9, 2017

(54) A PROCESS FOR THE ELIMINATION OF VOLATILE ORGANIC COMPOUNDS AND HAZARDOUS AIR POLLUTANTS IN AMMONIA PLANTS

(71) Applicant: Haldor Topsøe A/S, Kgs. Lyngby (DK)

(72) Inventors: Niels Ulrik Andersen, Gentofte (DK); Per Jul Dahl, Vedbæk (DK); Vinay Avasthi, Haryana (IN)

(73) Assignee: Haldor Topsøe A/S, Kgs. Lyngby (DK)

(21) Appl. No.: 15/526,020

(22) PCT Filed: Nov. 25, 2015
(86) PCT No.: PCT/EP2015/077598

§ 371 Date: May 11, 2017

(30) Foreign Application Priority Data
Dec. 1, 2014 (IN) 3495/DEL/2014
Feb. 11, 2015 (DK) PA 2015 00076

(51) Int. Cl. C01B 3/02; C01B 32/50; C01C 1/04; C01B 3/12; C01B 3/38

(52) U.S. Cl. CPC C01B 3/025; C01B 3/12; C01B 3/38; C01C 1/04; C01B 32/50; C01B 2203/0233; C01B 2203/0475; C01B 2203/048; C01B 2203/068; C01B 2203/0283

(57) ABSTRACT

In a process for the elimination of volatile organic compounds (VOCs) and hazardous air pollutants (HAPs) formed as by-products in the shift section (SS) of an ammonia plant, a carbon dioxide (C0₂) stream from a vent line, which is arranged downstream from the shift section and the C0₂ removal section, is recycled to the primary reformer (TR) of the ammonia plant. This way, the oxygenates contained in the carbon dioxide vent will be decomposed in the primary reformer burners, and the total emission of VOCs and HAPs will be considerably reduced.

The present invention relates to a process for the elimination of emissions of volatile organic compounds (VOCs) and hazardous air pollutants (HAPs) from the carbon dioxide (CO₂) vent in ammonia plants. More specifically, the invention relates to the elimination of VOCs and HAPs in a syngas preparation process.

In an ammonia plant certain by-products (mainly oxygenates and from this group mainly methanol) are formed in the shift section, in particular in the low temperature shift (LTS) section. Some of these compounds, including methanol, are very volatile, and they will enter into the gaseous phase to the CO₂ removal section. However, due to the very high liquid/gas ratio in the CO₂ removal section, the concentration of these oxygenates will increase in the CO₂ removal solution until eventually a balance is established. The oxygenates introduced to the CO₂ removal section will exit mainly with the CO₂ stream. This CO₂, or at least part of it, will be vented to the atmosphere and act as a pollutant.

According to the prior art, the oxygenates are typically removed by scrubbing the CO₂ stream with a liquid, preferably water. However, some of the by-products are too volatile to be absorbed in the scrubber liquid. Instead, they will be discharged to the atmosphere, where they will cause an unacceptable pollution.

US 2010/0310949 discloses a process for preparing a hydrogen-containing product gas suitable for methanol and ammonia production, whereby CO₂ is captured and its emission into the atmosphere is reduced. The process is based on reforming of a steam/hydrocarbon mixture in the tubes of a reformer with a furnace, whereby a reformate stream comprising H₂, CO, methane (CH₄) and steam is formed. This step is followed by an optional secondary reforming step and then a shift step (e.g. LTS) to form a second process stream comprising CO₂, CO, H₂ and CH₄. This second process stream is scrubbed for carbon dioxide removal, and then portions of the resulting CO₂-depleted stream can be used as fuel in the furnace of the reformer to prevent build-up of inert compounds, N₂ and argon.

The process according to US 2010/0310949 has nothing to do with the process of the invention. Thus, the known process uses the CO₂-depleted stream as a fuel, while the CO₂ in the CO₂-rich stream is expected to be utilized. The purpose is to reduce the CO₂-slip into the atmosphere by removing CO₂ from the fuel gas in such a way that this CO₂ can be recycled. The present invention is based on removing CO₂ from the CO₂-rich stream and feeding it to the reformer to have any VOC removed therefrom before the CO₂ is vented to the atmosphere. This step is justified because the CO₂ in any case is to be vented to the atmosphere.

US 2014/0186258 discloses a method for producing hydrogen by steam-reforming of biomethane followed by a shift step. The shifted syngas is purified by pressure swing adsorption (PSA), including at least one step of purifying a first portion of the biogas containing (amongst other compounds) VOCs, said biogas being supplied for producing biomethane, which is reformed, the resulting syngas being shifted and purified by PSA. The waste gas from the PSA is used as a secondary fuel for the reforming furnace, raw or partially purified biogas being used as primary fuel for the furnace. It is stated in US 2014/0186258 that the process of purification of biogas into biomethane consists of elimination of CO₂ accompanied by the elimination of harmful substances present in the biogas, including VOCs. In this process, harmful VOCs are eliminated from a fuel by using it as a fuel for reforming.

WO 2013/049368 discloses a process whereby dry syngas, obtained from a steam reformed and shifted biogas, is separated into its constituents by PSA to obtain a hydrogenrich flow and a flow of PSA waste gas. The PSA waste gas is recycled to supply the burners of the steam reformer furnace with fuel. The biogas is pre-purified by eliminating the VOCs, using e.g. adsorption at a modulated temperature (TSA).

US 2006/0260193 and US 2011/0232277 both describe a method and a device for producing a reformate fuel from a hydrocarbon gas source. Gases having low concentrations of hydrocarbons, that readily evaporate into air and may contain straight chain, branched, aromatic or oxygenated hydrocarbons, are concentrated into a gaseous or liquid VOC fuel. The concentrated VOC fuel is then converted into a reformate of hydrogen and carbon oxides, which is more easily consumed by an energy conversion device, such as a combustion engine or a fuel cell, that converts chemical energy into kinetic or electrical energy.

The present invention relates to a process for the elimination of volatile organic compounds (VOCs) and hazardous air pollutants (HAPs) formed as by-products in the shift section of an ammonia plant, wherein a carbon dioxide (CO₂) stream from a vent line, which is arranged downstream from the shift section and the CO₂ removal section, is recycled to the primary reformer of the ammonia plant.

Thus, the present invention relates to a process for the elimination of emissions of volatile organic compounds and hazardous air pollutants from a carbon dioxide (CO₂) vent in an ammonia plant. The processes carried out in an ammonia plant i.a. comprise feeding fuel to a tubular reforming section, passing the effluent from the tubular reforming section to a secondary reformer and then to the shift section, and passing the effluent from the shift section to a CO₂ removal unit, where the CO₂ is separated from the syngas. This CO₂, or at least part of it, is vented to the atmosphere.

The synthesis gas generation part of an ammonia plant roughly consists of a desulfurisation section, such as a hydrodesulfurisation (HDS) section (necessary in order to avoid poisoning of the catalyst in the downstream steam reformer), a reforming section, a shift section, a carbon dioxide removal unit, a methanator and an ammonia synthesis unit. The reforming section can for example be based on a tubular reformer preceded by a pre-reformer. The pre-reformer is used for low temperature steam reforming of a hydrocarbon feed such as natural gas. It provides complete conversion of higher hydrocarbons and removal of sulfur, and it is also protecting the downstream catalyst.

The pre-reformer is placed upstream from the tubular reforming unit. In order to obtain the required steam-tocarbon ratio, the feed is mixed with process steam before entering the pre-reformer. In the pre-reformer, all higher hydrocarbons are converted into a mixture of carbon oxides, hydrogen and methane.

In an ammonia plant the carbon monoxide conversion unit is located downstream from the secondary reformer.

The purpose of the shift section is to maximise the hydrogen output and reduce the carbon monoxide level in the synthesis gas.

In an ammonia plant, the shift section normally consists of a high temperature shift (HTS) reactor followed by a low temperature shift (LTS) reactor. The shift section may optionally consist of a medium temperature shift (MTS) reactor followed by a low temperature shift (LTS) reactor. To ensure that the synthesis gas in an ammonia plant being fed to the ammonia synthesis loop is free from carbon oxides, it is passed through a methanator, which will convert any traces of carbon dioxide and unconverted carbon monoxide from the shift section into methane.

The performance of the shift unit strongly affects the overall energy efficiency of the ammonia plant, because unconverted carbon monoxide will consume hydrogen and form methane (CH₄) in the methanator, thereby reducing the feed and increasing the inert gas level in the synthesis loop.

In the following, the invention will be explained in detail with reference to the figures, which show the parts of an ammonia plant which are relevant in connection with the invention. A feed stream f from a pre-reformer is led through a tubular reformer TR to which fuel and optionally combustion air CA is also supplied. The flue gas from the tubular reformer is sent via a waste heat recovery section (WHS) to the stack.

The effluent from the tubular reformer is routed to a secondary reformer SR and shift section SS for cooling and separation. Then carbon dioxide is separated from the stream, which then consists of syngas to be routed to a methanator (not shown). After venting off some of the separated CO₂, the rest is routed to e.g. urea production.

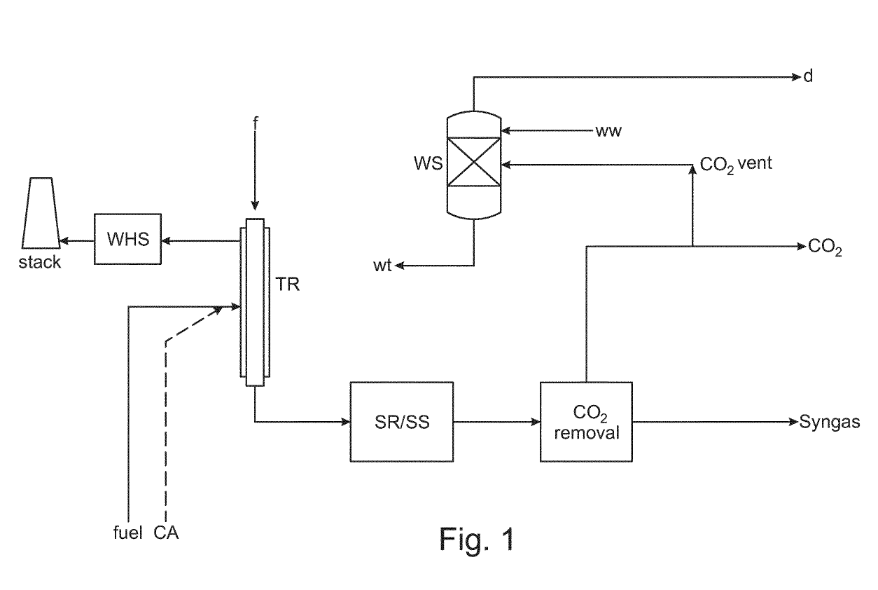

According to the prior art illustrated in FIG. 1, the CO₂ vent, which typically contains approximately 300 ppm methanol, 5 ppm dimethyl ether, 50 ppm methyl formate and 15 ppm acetaldehyde, is washed by scrubbing it with a liquid, preferably water, in a wash system WS. However, as already mentioned, the pollutant compounds in the CO₂ vent are in general much too volatile to be sufficiently absorbed in the scrubber liquid. More specifically, the gas discharged to the atmosphere after the scrubbing process still contains around 15 ppm methanol, 5 ppm dimethyl ether, 40 ppm methyl formate and 15 ppm acetaldehyde.

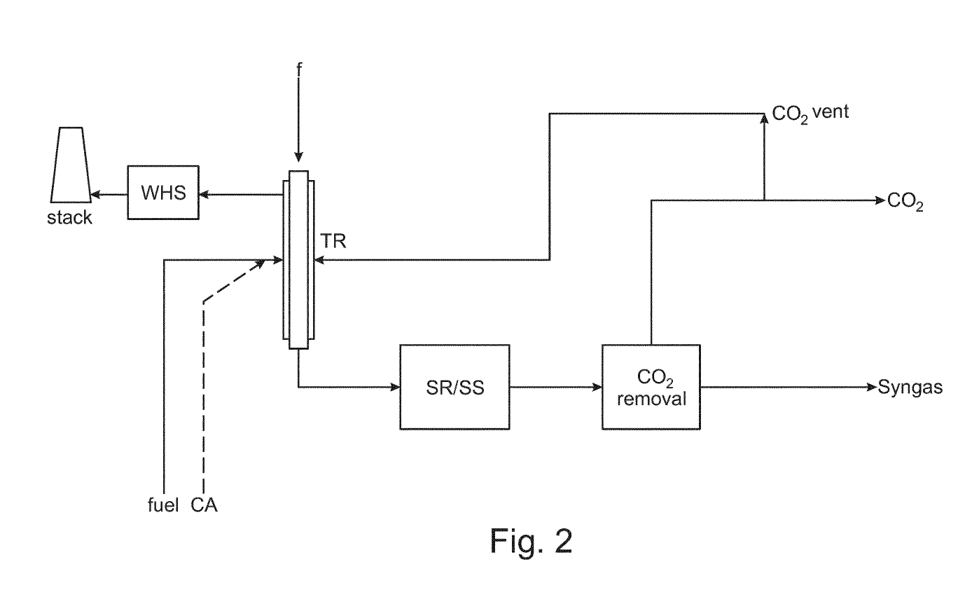

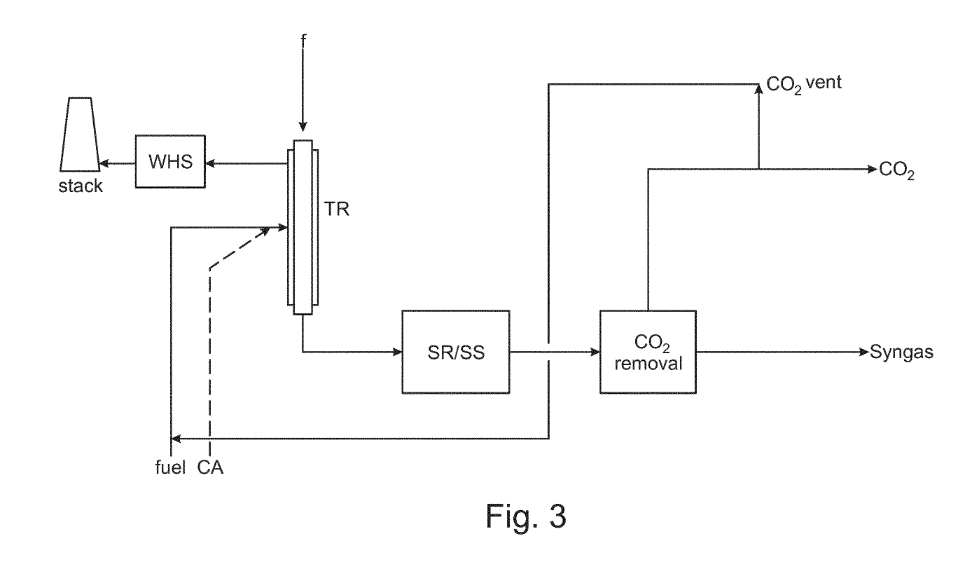

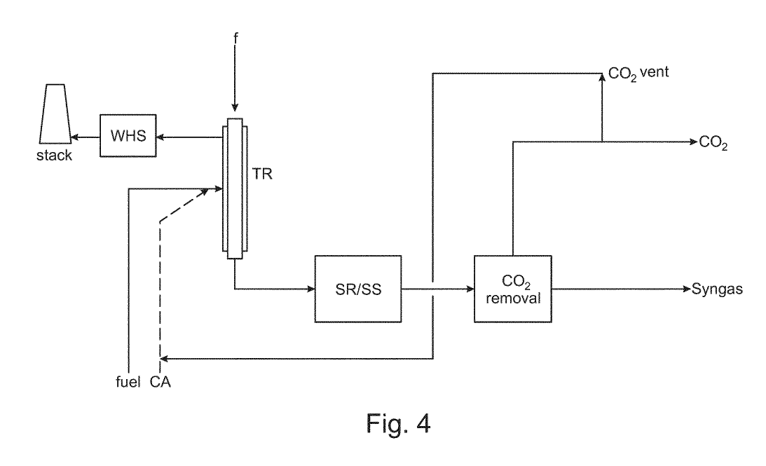

In the process according to the invention for elimination of emissions of volatile organic compounds (VOCs) from the carbon dioxide (CO₂) vent in ammonia plants, the CO₂ vent gas is instead routed to the tubular (primary) reformer (FIG. 2), especially to the combustion chamber of the primary reformer. Preferably the CO₂ vent is routed to the fuel system of the primary reformer (FIG. 3) and most preferably to the combustion air system (FIG. 4).

By recycling the carbon dioxide stream from the vent line to the primary reformer of the ammonia plant, the oxygenates contained in the carbon dioxide vent will be decomposed in the primary reformer burners, and the total emission of VOCs and HAPs will be considerably reduced compared to the scrubber solution of the prior art. In addition, the need for expensive equipment, which is necessary in relation to the scrubber solution and the treatment of the waste liquid stream, will be eliminated.

1. A process for the elimination of volatile organic compounds (VOCs) and hazardous air pollutants (HAPs) formed as by-products in the shift section of an ammonia plant, wherein a carbon dioxide (CO₂) stream from a vent line, which is arranged downstream from the shift section and the CO₂ removal section, is recycled to the primary reformer of the ammonia plant.

2. The process according to claim 1, wherein the CO₂ stream is recycled to the fuel system of the primary reformer.

3. The process according to claim 1, wherein the CO₂ stream is recycled to the combustion air system of the primary reformer.

4. The process according to claim 1, wherein the CO₂ stream is recycled to the combustion chamber of the primary reformer.

5. The process according to claim 2, wherein the CO₂ stream is recycled to the combustion air system of the primary reformer.

6. The process according to claim 2, wherein the CO₂ stream is recycled to the combustion chamber of the primary reformer.
